(19) United States
(12) Patent Application Publication
(10) Pub. No.: US 2013/0287976 A1
(43) Pub. Date: Oct. 31, 2013

(54) ANISOTROPIC ELONGATED METALLIC STRUCTURAL MEMBER

(71) Applicants: Gino Palumbo, Toronto (CA); Klaus Tomantschger, Mississauga (CA)

(72) Inventors: Gino Palumbo, Toronto (CA); Klaus Tomantschger, Mississauga (CA)

(73) Assignee: Integran Technologies Inc., Mississauga (CA)

(21) Appl. No.: 13/457,101

(22) Filed: Apr. 26, 2012

(51) Int. Cl. B32B 1/04; B32B 17/00; B32B 18/00; B32B 1/08; B32B 15/02

(52) U.S. Cl. 428/34.1; 428/397; 428/399; 428/367; 428/375

(57) ABSTRACT

An elongated metallic structural member having anisotropic flexural stiffness characteristics which can be conveniently produced, is disclosed. Anisotropic bending behavior is achieved by directionally controlling, at least in part, the composition and/or microstructure. The invention is particularly applicable to articles requiring the bending stiffness in the flexible plane to be much lower than in the stiff plane as desired, among others, in a variety of shafts, tubes and rods used in sporting goods.

### FIELD OF THE INVENTION

The present invention relates to metallic elongated structural members that have anisotropic flexural and/or bending stiffness characteristics. The invention is particularly applicable to articles requiring at least one flexible plane and at least one stiff plane as desired, among others, in a variety of shafts, tubes and rods used in sporting goods.

### BACKGROUND OF THE INVENTION

Modern lightweight and durable articles, e.g., sports equipment, require physical properties which frequently are not achievable with a monolithic and uniform material. The present invention discloses elongated metallic structural members having an anisotropic flexural and bending stiffness and typically operate in a unidirectional flexural manner.

The prior art discloses a number of approaches to change the flexural stiffness of a tubular article by strategically placing or integrating reinforcement additions and/or inserts and the like on selected parts and/or locations of the article. All the prior art approaches are based on the principle that in the direction of minimum flexibility and maximum stiffness, the ultimate material thickness is lower than in the direction of maximum flexibility and minimum stiffness, which is achieved by various continuous or discontinuous material additions or removal of material in one or more directions such as by the addition of ribs or grooves.

Doble in U.S. Pat. No. 7,726,346 (2010) describes an adjustable tubular structural member that provides adjustable directional resistance and stiffness to a device such as a golf shaft. When oriented in a certain manner with respect to the direction of use, the tubular structural member provides a different stiffness to the device it is affixed to. Doble achieves his objective by strategically adding or removing material along the length of the structural member.

Gazarra in US 2008/0168699 applies the same approach of selectively varying the material thickness to adjust the stiffness of fishing rods.

Locarno in U.S. Pat. No. 6,113,508 (2000) describes various sporting goods having a body with an elongated cavity and a stiffening rod that is being inserted into the cavity. The stiffening rod is stiffer in one direction and more flexible in a different direction, both the stiff and flexible direction being transverse to the longitudinal axis. This is achieved with stiffening rods having a cross-section which is I-shaped, i.e., the stiffening rod has at least two oval or rectangular gaps, or an oval core.

Boesman in U.S. Pat. No. 6,777,081 (2004) discloses a method to reinforce stiff composite articles, comprising metallic elements that run parallel to each other and through the composite structure. Typical reinforcing structures are metal wires or cords that are encased in polymers and improve the bending properties of the composite.

The prior art discloses the use of fine-grained and/or amorphous metallic materials for use in articles, including sporting goods:

Palumbo describes various articles for use in sporting goods, automotive, and industrial applications that are at least partially electroplated with fine-grained layers of selected metallic materials such as golf shafts in U.S. Pat. No. 7,354,354 (2008) and U.S. Pat. No. 7,387,578 (2008), and baseball bats in U.S. Pat. No. 7,591,745 (2009) and U.S. Pat. No. 7,803,072 (2010).

Tomantschger in US 2009/0159451 and US 2011/0256356 describes variable property deposits consisting of, at least partially fine-grained and/or amorphous metallic materials, optionally containing solid particulates. The electrodeposition conditions in a single plating cell are suitably adjusted to vary at least one property in the deposit direction. In one embodiment, denoted multidimensional grading, property variation along the length and/or width of the deposit is provided.

### SUMMARY OF THE INVENTION

It is an objective of the invention to provide an anisotropic elongated structural member that can be used as a stand-alone article or a sheath placed over or inside a part of the device along the longitudinal direction to affect the directional stiffness. The present invention is particularly suited for tubes, rods and the like used in sporting goods, such as golf shafts, ski poles, hockey sticks, lacrosse sticks, field hockey sticks, baseball and softball bats, fishing rods, vaulting poles, boat oars, masts for sailing vessels, bicycle parts, rowing oars and other articles where it may be desirable to have the flexural and bending stiffness change in one or more directions, e.g., along the lateral and/or the central axis/longitudinal axis of the article.

It is an objective of the invention to provide an anisotropic metallic structural and/or structural member, having at least one stiff plane and at least one flexible plane, comprising at least one metallic element and optionally containing particulates, as a coating (on at least part of a surface of a substrate) or in free-standing form. The microstructure can be crystalline with the grain size varying with direction, i.e., between an average grain size of between 1 nm and 300 μm and/or an amorphous microstructure.

It is an objective of the invention to provide an anisotropic elongated structural member having a cross-sectional area at any location along the vertical axis that is uniform and the elastic properties within each cylindrical ring section are rendered anisotropic by changing the composition, microstructure or by layering. Preferably, there is a symmetry in elastic properties within each ring section, i.e., a relative low elastic modulus in the front and back to enable the ring section to readily flex back and forth (referred to as the 6 and 12 o'clock position or to the 0° and 180° plane) and a continuously or abruptly increasing modulus along both sides which typically reaches a maximum at the 3 and 9 o'clock position or to the 90° and 270° plane. The two halves obtained when slicing the ring section along its longitudinal axis along the 6 and 12 o'clock position, or along the stiff or the flexible plane, are preferably symmetrical in elastic/bending properties.

It is an objective of the invention to provide an anisotropic elongated structural member having a cross-sectional area which is circular and having a uniform wall thickness throughout.

The properties being altered to achieve the desired anisotropy include the grain size, crystallographic orientation, crystallographic texture, yield strength, Young's modulus, resilience, elastic limit, ductility, internal or residual deposit stress, flexural and/or bending stiffness, chemical composition and, in the case of metal matrix composites, volume particulate fraction, particulate particle size, particulate shape and/or particulate chemistry. The variation in a property between grades (levels) is at least 5%, preferably at least 10%, more preferably at least 50%, and even more preferably at least 100%.

The anisotropic elongated structural member is particularly suited for applications where the article is repeatedly bent along the longitudinal axis during use, however, any lateral movement, i.e., any “twist” is undesired as it adversely affects the performance. The anisotropic elongated structural member is also particularly suited for applications where bending/flexing along the longitudinal axis always occurs along the same plane, i.e., unidirectional, as is the case in articles comprising the elongated structural member and an attachment dictating the preferred bending mode orientation, e.g., attaching a golf club head to a golf shaft, a rudder blade to an ore or a reel to a fishing rod. In golf shafts, particularly in drivers and irons, any twist during flexing will compromise the directional consistency of the ball trajectory resulting in disbursements and loss of accuracy in ball placement. Similarly, in the case of oars for rowing, an undesired lateral twist will reduce the effectiveness and efficiency of transforming the applied energy to the movement/speed of the vessel. The present invention also conveniently provides the ability for fabricating articles tailored to user specific designs and preferences where the torsional twist during use is limited to no more than 10°, preferably no more than 5° and even more preferably no more than 1°.

The present invention relates to elongated structural members that require a directionally optimized flexural stiffness which is greater in at least one lateral direction and/or longitudinal direction. The present invention particularly relates to elongated structural members requiring at least one stiff plane and at least one flexible plane extending radially from the longitudinal axis with a relative angle to each other of at least 22.5°, preferably of 90+/−10°.

The preferably circular elongated structural member comprises a coherent metallic material not requiring holes, grooves, ribs and the like to be rendered anisotropic to predominantly bend in the same direction when loaded. Unlike the prior art, which typically selectively adds or removes materials or changes the cross section, the anisotropic elongated structural member of this invention achieves the same properties with a relatively uniform cross-sectional wall thickness by affecting the physical properties of the metallic materials accordingly. The anisotropic elongated structural member is placed over the core or in the center of the article to be modified in a particular orientation at the time of manufacture or later, prior to or during use, allowing the orientation of the maximum flexural resistance of the article to be set permanently or changed at will.

It is therefore an objective of the invention to provide an anisotropic metallic structural member where the Young's modulus and/or the bending stiffness normalized for the layer/wall thickness has different values depending on the direction of the applied force under tensile, compressive or bending loading. The difference in the normalized Young's modulus and/or the bending stiffness, normalized for wall thickness, between the direction of lowest stiffness and the direction of the highest stiffness is at least 5%, preferably at least 10% and more preferably at least 50%.

It is known that Young's moduli of metals and their bending stiffness are inherently isotropic and that their mechanical properties are the same in all orientations. It is therefore the objective of the present invention to alter physical and chemical properties within the cross-sectional plane and/or along the length of the metallic structural member to affect Young's modulus and/or the bending stiffness and render the bending behavior of the elongated structural member directionally dependent by changing the composition and/or the microstructure, including, but not limited to, grain size, texture/grain orientation and/or by applying layering to locally, e.g., in the desired cross-sectional sector, obtain the “supermodulus effect”.

The invention is applicable, in particular, to articles having a rod or shaft which flexes along its length in a preferred direction such as sports equipment including, but not limited to, golf clubs, hockey sticks, field hockey sticks, lacrosse sticks, bats, oars, masts, fishing rods, vaulting poles, sail boat masts and polo mallets; as well as aerospace and other industrial components.

The elongated structural member can also be tapered from one end to the other, and can be continuously or step-wise tapered so that its shape fits the requirements of the device.

It is also an objective of the present disclosure to provide strong and lightweight anisotropic metallic structural members comprising fine-gained and/or amorphous metallic layers, including sub-layers, that are stiff; lightweight, resistant to abrasion, resistant to permanent deformation and do not splinter when cracked or broken.

It is an objective of this disclosure to at least partially coat the inner or outer surface of parts, including complex shapes, with anisotropic metallic structural layers which are fine-grained and/or amorphous and are strong, lightweight and have directionally varying stiffness in at least one longitudinal or lateral plane.

Accordingly, the present disclosure is directed to an elongated anisotropic tubular structural metallic member having a longitudinal axis; a cross-section which is uniform in thickness or size along its entire longitudinal axis; and at least one flexible plane and at least one stiff plane wherein said at least one flexible plane and said at least one stiff plane extend radially from said longitudinal axis, and wherein the bending stiffness normalized for wall thickness in the stiffest plane is at least 5% greater than the bending stiffness normalized for wall thickness in the most flexible plane; and the angle between said stiffest plane and said most flexible plane is at least 22.5°.

Accordingly, the present disclosure is also directed to a golf shaft assembly including: a tapered hollow shaft having a circular cross-section, having a first end comprising a grip end a second end containing a golf club head, said shaft having a bend point along the shaft, said tapered hollow shaft containing or consisting of an elongated anisotropic elongated structural metallic member having a longitudinal axis, at least one flexural plane and at least one stiff plane; wherein said flexible plane(s) and said stiff plane(s) extend radially from said longitudinal axis and where the angle between the stiffest plane and the most flexible plane is at least 22.5°, and wherein the bending stiffness normalized for thickness in said stiffest plane is at least 5% greater than the bending stiffness normalized for thickness in said most flexible plane.

### DEFINITIONS

As used herein, the term “article” means an item, a portion or all of which containing the anisotropic metallic structural member.

As used herein the term “stiffness” means the resistance of an elastic body to deflection or deformation by an applied force.

Anisotropic elongated metallic structural members can be characterized by a number of parameters including their “bending stiffness” and “vibrational bending frequency”.

The “bending stiffness” of an elongated metallic structural member is a measure of how much the elongated metallic structural member will bend due to an applied force at a specified location, e.g., half way between the structural member's ends and in a specified direction.

The “bending stiffness normalized for wall thickness” is obtained by holding or securely mounting the elongated anisotropic tubular structural metallic member at each end and applying a force, e.g., half way between its ends in rotational increments of at least 5° and measuring the applied force to obtain the same specified deformation, or applying the same force and measuring the resulting deflection and expressing the results normalized for the average wall thickness.

As used herein “cross-sectional sector” is defined as the sector which extends from the stiff plane to half the distance on either sides to the adjacent flexible plane(s).

The “vibrational bending frequency” is the frequency at which an elongated metallic structural member vibrates when bent and then is suddenly released, e.g., a golf shaft when being held at the grip and deflected at the golf club head. As the shaft vibrates, the number of times that the head end moves back and forth, per time period unit, is its “vibrational bending frequency”.

As used herein the term “direction” refers to at least one of the three dimensional Cartesian coordinates defining the three physical directions/dimensions of space, the length, width, and height, which are perpendicular to each other. The depth or height of a metallic layer is defined by the deposition direction as indicated hereinafter and indicates the thickness of the metallic layer. Length and width directions are perpendicular to the depth or height direction. If a substrate to be plated is cylindrical in shape such as a tube, the length is the longitudinal axial direction and deposition occurs in the radial direction.

The terms “anisotropic” and “variable property” in this context refer to several structures: (i) graded structures, wherein at least one property such as the elastic or bending modulus normalized for the average wall and/or average cross-sectional thickness is being varied by at least 5% in one or more directions, i.e., along the width or length of the elongated structural member, (ii) layered structures, comprising multiple sublayers with different properties sandwiched/stacked on top of each other and (iii) mixed variable property and layered structures wherein the elongated structural member contains sub-structures comprising both (i) and (ii). Properties within a sublayer, which is defined as having a minimum thickness of 1 nm, are varied in at least some of the layers to achieve the desired elastic anisotropy. Therefore there can be a gradual or stepwise/abrupt change in properties (e.g., the grain size) between sublayers. Sublayers with different properties can then be alternated or new properties can be introduced in subsequent sublayers to assemble the ultimate elongated structural member.

As used herein, the term “anisotropic material” means a material having at least one property in a layer or cross sectional area modified by at least 5%. As used herein the term “deposit” means deposit layer or five-standing deposit body.

As used herein, the teen “metallic coating”, “metallic layer” or “metallic material” means a metallic deposit/layer applied to part of or the entire exposed surface of an article. The substantially porosity-free metallic coating (porosity≦1.5%) is intended to adhere to the surface of the substrate to provide mechanical strength, wear resistance, corrosion resistance, anti-microbial properties and a low coefficient of friction and to provide the anisotropic flexing properties.

As used herein, the term “metal matrix composite” (MMC) is defined as particulate matter embedded in a fine-gained and/or amorphous metal matrix. MMCs are produced, e.g., by suspending particles in a suitable plating bath and incorporating particulate matter into the deposit by inclusion as opposed to chemical reduction.

As used herein, the term “thickness” refers to, e.g., the “coating thickness”, “layer thickness” or the “wall thickness” of a reinforcing member.

As used herein, the term “surface” means a surface located on a particular side of an article. A side of an article may include various surfaces or surface areas. Thus, when indicating a coating is applied to a “surface” of an article, it is intended that such “surface” can comprise any one or all of the exposed surfaces or surface areas located on that particular side of the article being coated.

As used herein the term “chemical composition” means chemical composition of the anisotropic metallic structural member.

As used herein the term “yield strength” or “yield point” of a material is defined as the stress at which a material begins to irreversibly deform plastically, i.e., the maximum stress that can be applied without exceeding a specified value of permanent strain.

As used herein the “elastic limit” is defined as the lowest stress where permanent deformation occurs (i.e., the maximum stress that can be applied without resulting in permanent deformation when unloaded), and “percent elongation” means the strain at fracture, expressed as a percentage, and is a measure of ductility.

As used herein “fatigue” is the progressive and localized structural damage that occurs when a material is subjected to cyclic loading and the “fatigue life” is the number of stress cycles that a specimen can sustain before failure.

As used herein the “elastic modulus” or “Young's modulus”, also known as the tensile modulus, is a measure of the stiffness of an elastic material. It is defined as the ratio of the uniaxial stress over the uniaxial strain in the range of stress in which Hooke's Law holds where the Young's modulus is essentially constant over a range of strains. It can be experimentally determined from the slope of the linear portion of a stress-strain curve.

As used herein the “supermodulus effect” is defined as a phenomenon, observed at times, whereby the elastic constant increases by over 100% and as much as over nine times in multilayer thin films of alternating composition such as, e.g., Cu—Ni, which can be achieved e.g. by nano-layering metals or alloys when individual layers' thicknesses decrease to at least under 200 nm, preferably under 100 nm, and more preferably under 10 nm.

As used herein the term “laminate” or “nanolaminate” means a metallic material that includes a plurality of adjacent layers that have an individual thickness between 1 nm and 5 microns. A “layer” of a metallic material or of a laminate or nanolaminate means a single thickness of a substance where the substance may be defined by a distinct composition, microstructure, phase, grain size, physical property, chemical property or combinations thereof. It should be appreciated that the interface between adjacent layers may not be necessarily discrete but may be blended, i.e., the adjacent layers may gradually transition from one of the adjacent layers to the other of the adjacent layers.

As used herein the term “compositionally modulated material” means a material whose chemical composition is continuously, periodically or abruptly altered in in a layer or cross sectional area.

According to another aspect of the present disclosure, the anisotropic metallic material may be applied to the entire article, or in certain regions, e.g., using electrodeposition, by immersing the article at least partially into the plating solution and applying D.C. or pulsed current to the article and one or more anodes, using one or more power supplies.

Elongated anisotropic structural metallic members of the present disclosure comprise, at least in part, fine-grained and/or amorphous metallic layers having a total wall thickness of at least 0.001 mm, preferably more than 0.010 mm, preferably more than 0.02 mm, more preferably more than 0.03 mm and even more preferably more than 0.05 mm.

Elongated anisotropic structural metallic members of the present disclosure comprise a single or several fine-gained and/or amorphous metallic layers or multi-layer laminates composed of alternating layers of fine-gained, amorphous and/or coarse-gained metallic layers of the same or different chemical composition.

The metallic coatings/layers can be fine-grained having a gain size under 10 mm (10,000 nm), preferably in the range of 2 to 1,000 nm, more preferably between 10 and 500 nm. The grain size can be uniform throughout the deposit; alternatively, it can consist of layers with different microstructure/grain size. Amorphous microstructures and mixed amorphous/crystalline microstructures are within the scope of the present disclosure as well, as are graded and laminated metallic materials. Layering and/or grading the metallic layer by changing the composition, grain size or any other physical or chemical property is within the scope of this invention as well.

According to this disclosure the entire interior or exterior surface of an article can be coated. Alternatively, metal patches or sections can be formed on selected areas only and, as highlighted, metal patches or sleeves comprise anisotropic properties in areas particularly prone to high tensile, flexural stresses, or hoop stresses.

The following listing further defines the anisotropic metallic structural member of the present disclosure:

TABLE 1
Anisotropic Metallic Structural Member Specification:

| Minimum yield stress, as measured by ASTM E8 [MPa]: | 300; 500; 700 |
|---|---|
| Minimum strain to yield, as measured by ASTM E8 [MPa]: | 0.2; 0.4; 0.5; 0.6; 0.7; 0.8; 1.0 |
| Maximum strain to yield, as measured by ASTM E8 [%]: | 5; 10; 15; 20; 25; 30; 50 |
| Microstructure: | Amorphous and/or crystalline |
| Minimum average gain size [nm]: | 1; 2; 5; 10 |
| Maximum average grain size [nm]: | 100; 500; 750; 1,000; 2,500; 5,000; |
| | 7,500; 10,000; 300,000 |
| Metallic wall thickness minimum [μm]: | 1; 10; 25; 30; 50; 100 |
| Metallic wall thickness maximum [mm]: | 5; 25; 50 |
| Minimum sublayer or laminate layer thickness [nm]: | 1; 2; 5; 10; 50; 100 |
| Maximum sublayer thickness [nm]: | 200; 500 |
| Maximum laminate layer thickness [mm]: | 5; 25; 50 |
| Chemical composition (the specific material contains at | Ag, Al, Au, Co, Cr, Cu, Fe, Ni, |
| least one element selected from the group listed): | Mn, Mo, Pb, Pd, Pt, Rh, Ru, Sn, |
| | Ti, W, Zn and Zr |
| Other alloying additions (the specific material contains at | H, C, H, N, O, P and S |
| least one element selected from the group listed): | |
| Particulate additions (the specific material contains at | metals (Ag, Al, In, Mg, Si, Sn, |
| least one element selected from the group listed): | Pt, Ti, V, W, Zn); metal oxides |
| | (Ag₂0, Al₂O₃, SiO₂, SnO₂, TiO₂, |
| | ZnO); carbides of B, Cr, Bi, Si, |
| | W; carbon (carbon nanotubes, |
| | diamond, graphite, graphite |
| | fibers); glass; glass fibers; |
| | polymer materials (PTFE, PVC, |
| | PE, PP, epoxy resins) |
| Minimum particulate/fiber fraction [% by weight or | 0; 1; 5; 10 |
| volume]: | |
| Maximum particulate/fiber fraction [% by weight or | 50; 75; 95; 99 |
| volume]: | |
| Minimum average particulate article size [nm] | 5; 50; 100; 500 |
| Maximum average particulate particle size [μm] | 25; 50; 100 |
| Minimum hardness [VHN]: | 25; 50; 100; 200; 400 |
| Maximum hardness [VHN]: | 800; 1,000; 2,000 |
| Minimum angle between stiff plane and flexible plane [°] | 15; 22.5; 30 |
| Maximum angle between stiff plane and flexible plane [°] | 60; 67.5; 90 |

### BRIEF DESCRIPTION OF THE DRAWINGS

In order to better illustrate the present disclosure by way of examples, descriptions are provided for suitable embodiments of the method/process/apparatus according to the present disclosure in which:

FIG. 1 shows an anisotropic elongated structural member depicting one flexible plane and one stiff plane.

FIG. 2 shows a cross-section of a tubular elongated anisotropic structural member according to one aspect of the present disclosure.

FIG. 3a shows the elastic modulus normalized for the average wall thickness of a cross-section of an elongated structural member, specifically along the direction labeled F to G in FIG. 1, referring to the “flexible plane”.

FIG. 3b shows the elastic modulus normalized for the average wall thickness of a cross-section of an elongated anisotropic structural member, specifically along the direction labeled A to B in FIG. 1, referring to the “stiff plane”.

FIG. 4 shows a cross-section through the wall of an elongated anisotropic structural member according to one aspect of the present disclosure revealing a layered structure comprising distinct sublayers.

### DETAILED DESCRIPTION

Elongated articles which are cylindrical in shape, such as tubes or rods having a circular cross-section, having a high flexural stiffness in one direction while having the flexural stiffness lowered or ideally even minimized in another direction, e.g., in the perpendicular direction, are required for a large number of applications. In order to achieve this goal in engineered products the cross-section can be divided, e.g., into four or more quadrants and the quadrants/sectors, diametrically opposed to each other, preferably have similar or identical properties. Changes in properties are therefore preferably gradual and not abrupt to avoid the formation of undesired interfaces usually being the location of failure in case of substantial loading.

Unlike anisotropic reinforcement members described in the prior art, the tapered elongated structural members described herein remain uniform in wall thickness in each cross-section and anisotropy is not achieved by simply strategically changing the thickness of the structural member but by affecting physical properties of the metallic material constituting the anisotropic structural members. The outer diameter, and/or, e.g., in the case the anisotropic elongated structural member is a tube, the inner diameter, optionally can change over the length of the anisotropic structural members and even the wall thickness can change along the length, too, however, the thickness or wall thickness remains uniform in the cross section of each segment along the length of the anisotropic structural members.

The outer diameter and the inner diameter, if any, of the anisotropic structural members can be uniform along the entire length of the anisotropic elongated structural member. Alternatively, the outer diameter and the inner diameter, if any, can be greatest at one end and smallest at the other end. When mated with a device as an outer sheath, the outer diameter of the device should match the inner diameter of the anisotropic elongated structural member to ensure good contact and reduced movement. Similarly, when mated with a device by insertion, the inner diameter and its profile along the device should match the outer diameter of the anisotropic elongated structural member.

Preferred embodiments according to the invention allow for stiffness changes along the appropriate dimension of the article by varying the elastic properties in the circular cross-section of the anisotropic structural member without changing the thickness. Other embodiments can employ flexural variations to occur along more than one axis. Other embodiments can include arranging multiple elongated structural members in an arrangement or to rotate the structural member, e.g., over a core, so as to allow the ultimate article comprising the elongated structural member(s) to have adjustable flexural resistance in more than one dimension or change the direction, for example, in articles that do not necessarily operate in a unidirectional flexural manner, such as a mast for a sailboat where it may be desired to rotate the anisotropic structural member to have its flexible or stiff plane constantly aligned e.g., with the sail or wind direction.

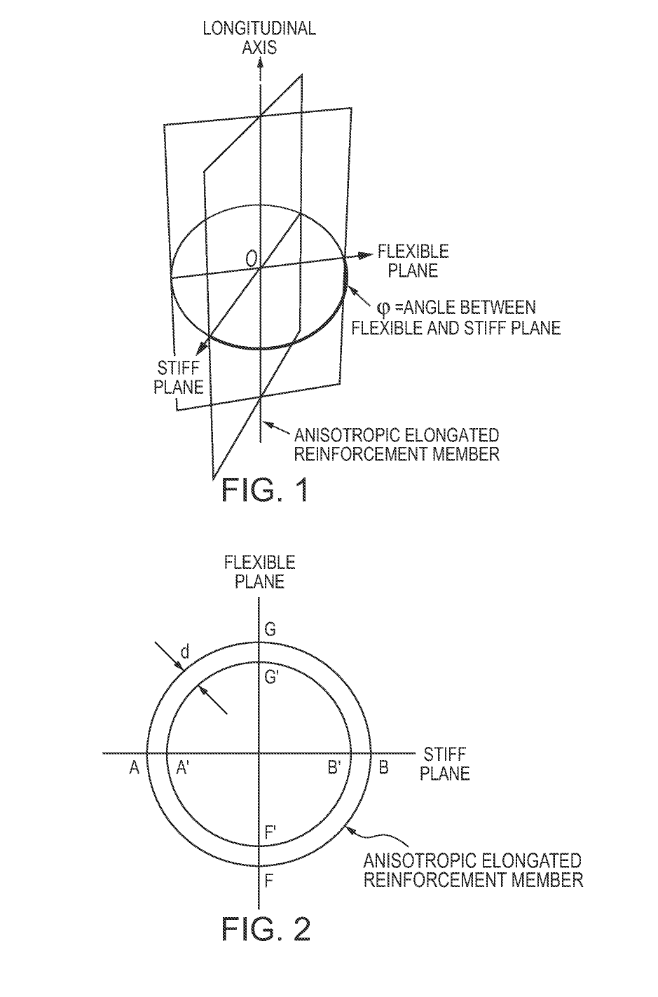

The elongated structural member employing varying directional stiffness according to one aspect of the present invention is illustrated in FIG. 1. The anisotropic structural member has a longitudinal axis and contains one flexible bending direction, labeled “flexible plane” and a stiff bending direction represented by the “stiff plane”. The angle between the stiff and the flexible directions, axis or planes is illustrated as well.

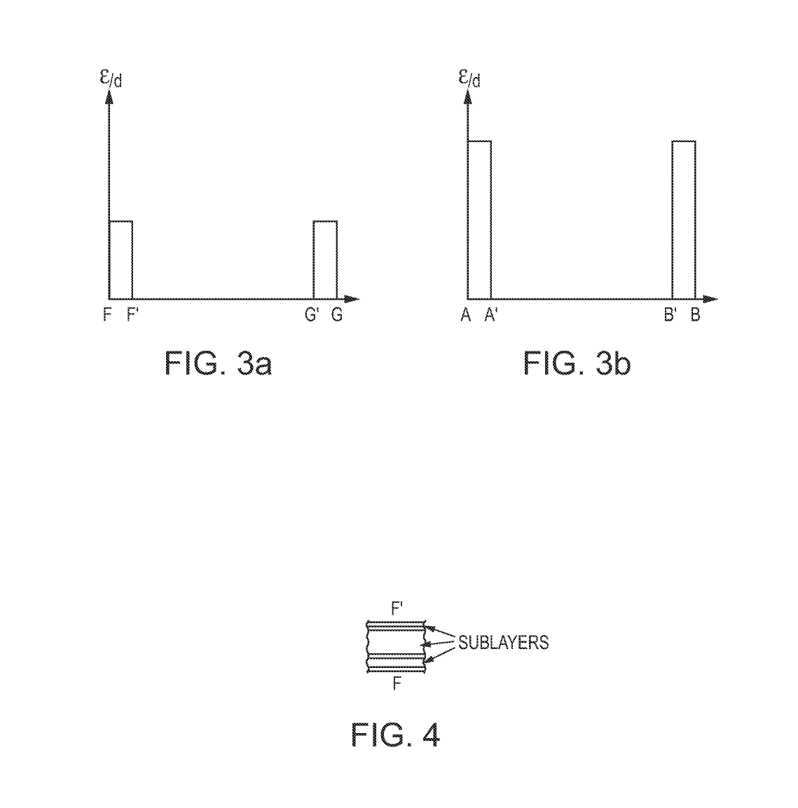

FIG. 2 schematically depicts the cross section perpendicular to the longitudinal axis of an elongated article representing or comprising a tubular anisotropic structural member having one stiff plane and one flexible plane and the angle between the stiff and the flexible plane is 90°. The flexural plane extending from F to A has the least flexural and/or bending resistance. The stiff plane extending from A to B represents the plane with the highest flexural and/or bending resistance. When a load is applied, the elongated structural member will bend in the flexible plane as this represents the direction of the least resistance to bending. The elongated structural member can still flex across the stiff axis or in any other direction, however, the level of force required will be higher than the force required to bend in the flexible plane and the required force will depend on the orientation. All flexing/bending occurs repeatedly within the elastic limit of the elongated structural member, i.e., no permanent deformation occurs during regular use and any plastic deformation would represent failure/end of life of the anisotropic structural member. FIGS. 3a and 3b illustrate the elastic modulus, normalized for wall thickness, of the anisotropic elongated structural member along the flexible plane (FIG. 3a) extending from F to G and of the anisotropic elongated structural member along the stiff plane (FIG. 3b) extending from A to B. The person skilled in the art will understand that along any other axis the elastic moduli, normalized for wall thickness, in height, would fall between the values depicted in FIGS. 3a and 3b. Similarly the force required to bend the anisotropic structural member in a certain direction, normalized for wall thickness, would yield similar results, i.e., the bending force, normalized for thickness, would be highest in the stiff plane and lowest in the flexible plane.

FIG. 4 schematically shows a cross-section through the wall of an elongated anisotropic structural member perpendicular to the longitudinal axis according to one preferred embodiment of the present disclosure revealing a layered structure comprising sublayers of equal and varying thickness. As highlighted, alternatively the cross-section can have a monolithic and/or a graded structure.

When the elongated structural member reinforces an article, it can be permanently attached to the article or it can be mounted to enable to change the direction of the maximum bending resistance of that article, e.g., by rotation relative to the article. Changing the radial orientation of the elongated structural member with respect to an article can be used to change the overall stiffness of an article, as required. Some articles have a particular bending plane or flexing direction dictated by their use, for example, a golf club shaft's stiffness is most important along the plane perpendicular to the golf club face plane.

The resistance to bending R of the elongated structural member can be expressed by the formula:

R=E*I

Where E is the modulus of elasticity for the elongated structural member and I represents the cross section moment of inertia. Both E and I can be calculated or measured and depend on the elongated structural member's geometry and composition. By changing either, or both, the modulus of elasticity or the cross-sectional moment of inertia, the resistance of the elongated structural member can be changed. Different embodiments of the elongated structural member can allow for either the modulus or the moment of inertia to be changed, so as to vary the bending resistance.

The vibrational bending frequency depends on the bending stiffness of the article containing the anisotropic elongated structural member, as well as its mass and the mass of any attachment, such as, e.g., in the case of a golf shaft, a golf club head. If the anisotropic elongated structural member is made stiffer, e.g., by increasing the overall mass of it and keeping the mass of the head constant, the vibrational bending frequency increases. Conversely, if the mass of structural member or attachment is increased, with the bending stiffness of structural member remaining constant, the vibrational bending frequency decreases.

The person skilled in the art of forming metallic layers or applying metallic coatings will know how to electroplate or electrolessly plate selected fine-grained and/or amorphous metals, alloys or metal matrix composites choosing suitable plating bath formulations and plating conditions. Similarly, the artisan familiar with physical vapor deposition (PVD), chemical vapor deposition (CVD) and gas condensation techniques will know how to prepare fine-grained and/or amorphous metal, alloy or metal matrix composite materials, layers or coatings with directionally varied bending stiffness.

Table 4 highlights the elastic moduli for selected metallic materials of interest as function of composition and microstructure.

TABLE 4

| | GRAIN SIZE | ELASTIC MODULUS |
|---|---|---|
| METAL TYPE | [nm] | [GPa] |
| Conventional coarse-grained Ni | >10,000 | 210 |
| Ultra-fine-grained Ni | 150 | 190 |
| Nanocrystalline Ni | 15 | 150 |
| Amorphous Ni | N/A | 65-75 |
| Coarse-grained Cu | >10,000 | 115 |
| Nanolayered Ni—Cu (2 nm | — | 1,800 |
| thick layers)*⁾ | | |
| Nanolayered Ni—Cu (4nm | — | 500 |
| thick layers)*⁾ | | |
| Coarse-grained Zn | >10,000 | 108 |

*⁾according to T. Tsakalakos and J. E. Hilliard, J. Appl. Phys. 54, 734 (1983).

As indicated, metallic coatings or layers of varying properties and microstructure can be conveniently formed with a number of processes. According to one aspect of the present disclosure, an article is provided by an electrodeposition process which comprises the steps of positioning a metallic or metallized work piece to be electroplated in a plating tank containing a suitable electrolyte and a fluid circulation system, providing electrical connections to the work piece/cathode to be plated and to one or several anodes and plating a structural layer of a metallic material on the surface of the metallic or metallized work piece using suitable direct current (D.C.) or pulse electrodeposition processes described, e.g., in the co-pending application US 2005/0205425. Changing the flexural or bending properties within the deposit by applying grading and/or layering is described in co-pending application US 2011/0256356 enabling the production of the anisotropic structural member in a single plating tank. Strictly speaking electrodeposition is not a “mere line of sight process”, but due to the throwing power encountered, can also be used to coat some work piece areas not in “direct view” of the anode(s) and is therefore a particularly suitable process. To achieve the desired anisotropic bending properties the structural member can be placed in a cell with one or more anodes which are all controlled individually or in pairs to achieve the desired variation in elastic properties. For instance, the work piece can be immersed in a bath and centered between two Ni anodes in the 12 and 6 o'clock position and two Cu or Zn anodes in the 3 and 9 o'clock position to form two each Ni rich and Cu or Zn rich layers with interfacial areas of Zn—Ni or Zn—Cu alloys changing in composition from Zn or Cu rich to Ni rich and vice-versa. Rotating the anodes or the work piece and synchronizing rotation with the applied power and anode positions allows for convenient layering of selected circular cross sectional segments, also called “sectors” while, e.g., keeping other sectors homogeneous with respect to composition, grain size, modulus and the like. Preferably, a fully dense metallic layer of a defined thickness with varying or uniform elastic properties is formed in each sector, as described. Thereafter or as an alternative, the structural member can then be rotated to overlay one or more layers of a pure metal, alloy or metal matrix composite to level any areas not totally uniform and end up with a substantially uniform wall thickness and circular cross-section and generate the supermodulus effect as desired in selected sectors, e.g., overlaying 20 to several 1,000 or 1,000,000 thin layers less than 4-100 nm thick. As the person skilled in the art will realize this approach provides the designer with a virtually unlimited number of options to form any desired cross-sectional sectors, layers and/or sublayers and achieve the directionally dependent flexural stiffness without adding or removing material and creating sites of predominant failure or prone to premature failure during use or in fatigue testing. The person skilled in the art will also realize that the anisotropic sector(s) does/do not have to extend along the entire length of the article, but to achieve the desired anisotropy, can be limited to one or several longitudinal portions thereof.

In the case one or more cross-sectional sector(s) is/are multi-layered, the resulting anisotropic structural member in each cross-sectional sector contains more than a single layer, preferably at least 2 layers, more preferably at least 25 layers, more preferably at least 250 layers and even more preferably at least 1,000 layers.

Variation in volume particulate fraction from one grade (level or layer) to a subsequent grade (level or layer) is obtained by modulating inert material additions. As only particulates suspended in the electrolyte and contacting the cathode will be incorporated into the deposit, agitation rate and flow direction can be used as suitable process parameters to change the particulate content in the bath and therefore in the deposit. When the agitation rate is reduced, particulates, depending on their density relative to the electrolyte, will either settle at the tank bottom or float at the top and thus not be incorporated in the deposit. When the particulate content in the electrolyte in the vicinity of the cathode is modulated the particulate content in the deposit can be varied to range from 0 to 95% by volume.

Variation in particulate particle size, particulate shape and particulate chemistry from one grade (level or layer or portion) to a subsequent grade (level or layer or portion) is obtained by suitably changing inert material additions.

As will be obvious to the person skilled in the art, the same properties can be achieved when, as an alternative to the chemical composition, or in addition to the chemical composition, the grain size and texture are varied in a controlled manner or a laminating process is employed.

In a preferred embodiment of the invention herein there is provided an anisotropic elongated structural member having one or more electrodeposited metallic layer(s), where at least one property of said metallic layer in adjacent cross-sectional segments is varied by at least 5% being selected from the group consisting of chemical composition, grain size, hardness, yield strength, Young's modulus, bending modulus, resilience, elastic limit, ductility, internal stress, stiffness, texture and in the case of metal matrix composite layer, volume particulate fraction, particulate particle size, particulate shape and/or particulate chemistry, said metallic layer having a fine-grained microstructure with an average grain size ranging from 1 to 10,000 nm and/or an amorphous microstructure throughout 1.5 nm to 5 cm of said thickness.

The selected property can be varied in the deposit direction (cross sectional sector) but also along the longitudinal axis of the elongated structural member, i.e., the deposition parameters are modulated to cause variation by more than 10% in at least one property not only along the depth of the deposit but along its length and/or width as referred to as multidimensional grading.

The anisotropic elongated structural member can be suitably exposed to a finishing treatment, which can include, among others, electroplating, i.e., chromium plating and applying a polymeric material, i.e., a paint or adhesive.

### VARIATIONS

The foregoing description of the invention has been presented describing certain operable and preferred embodiments. It is not intended that the invention should be so limited since variations and modifications thereof will be obvious to those skilled in the art, all of which are within the spirit and scope of the invention.

1. An elongated anisotropic structural metallic member having a longitudinal axis; a cross-section which is uniform in thickness or size along its entire longitudinal axis; and at least one flexible plane and at least one stiff plane, wherein said at least one flexible plane and said at least one stiff plane extend radially from said longitudinal axis, and wherein the bending stiffness normalized for wall thickness in the at least one stiff plane is at least 5% greater than the bending stiffness normalized for wall thickness in the at least one flexible plane; and the angle between said at least one stiff plane and said at least one flexible plane is at least 22.5°.

2. The elongated anisotropic tubular structural metallic member of claim 1 having a circular cross-section.

3. The elongated anisotropic tubular structural metallic member of claim 1 where the bending occurs within the elastic limit of said metallic member.

4. The elongated anisotropic tubular structural metallic member of claim 1 where the angle between said at least one stiff plane and said at least one flexible plane is at least 45° and wherein the bending stiffness normalized for wall thickness difference between the at least one stiff plane and the at least one flexible plane is at least 25%.

5. The elongated anisotropic elongated structural metallic member of claim 1, wherein said metallic member comprises at least one metallic material selected from the group consisting of:
(i) one or more metals selected from the group consisting of Ag, Al, Au, Co, Cr, Cu, Fe, Ni, Mn, Mo, Pd, Pt, Rh, Ru, Sn, Ti W, Zn and Zr;
(ii) pure metals or alloys containing at least one of the metals listed in (i), further containing at least one element selected from the group of B, C, H, O, P and S; and
(iii) any of (i) or (ii) where said metallic coating also contains particulate additions in the volume fraction between 0 and 95% by volume.

6. The elongated anisotropic elongated structural metallic member according to claim 1, wherein said metallic material contains particulate addition and said particulate addition comprises at least one material selected from the group consisting of a metal, a metal oxide, a carbide, a carbon based material, a ceramic material, glass, and a polymer material.

7. The elongated anisotropic metallic member according to claim 1, wherein said metallic material in at least one cross-sectional sector comprises at least one material selected from the group consisting of a monolithic material, a graded material, and a multi-layer laminate.

8. The elongated anisotropic elongated structural metallic member according to claim 1, wherein said metallic member has a wall thickness between 10 microns and 2.5 mm.

9. The elongated anisotropic elongated structural metallic member according to claim 1, wherein the angle between the at least one flexible plane and the at least one stiff plane ranges from 22.5° to 90°.

10. The elongated anisotropic elongated structural metallic member according to claim 1, wherein the angle between the at least one flexible plane and the at least one stiff plane is between 67.5° and 90°.

11. The elongated anisotropic tubular structural metallic member of claim 1 which is a tube or a rod.

12. The elongated anisotropic elongated structural metallic member according to claim 1, which is selected from the group consisting of golf shaft, ski pole, hockey stick, lacrosse stick, field hockey stick, baseball bat, softball bat, fishing rod, vaulting pole, boat oar, mast, and bicycle part.

13. The elongated anisotropic elongated structural metallic member according to claim 1, which is tapered and/or stepped.

14. The elongated anisotropic elongated structural metallic member according to claim 1, wherein said metallic material has a microstructure which, at least in part, is at least one of fine-grained with an average grain size between 2 and 5,000 nm and amorphous;

15. A golf shaft assembly including a tapered hollow shaft having a first end comprising a grip end a second end containing a golf club head, said shaft having a circular cross-section and having a bend point along the shaft, said tapered hollow shaft including an elongated anisotropic elongated structural metallic member having a longitudinal axis, at least one flexible plane and at least one stiff plane; wherein said at least one flexible plane and said at least one stiff plane extend radially from said longitudinal axis and where the angle between the at least one stiff plane and the at least one flexible plane is at least 22.5°, and wherein the bending stiffness normalized for wall thickness in said at least one stiff plane is at least 5% greater than the bending stiffness normalized for wall thickness in said at least one flexible plane.

16. A golf shaft assembly according to claim 15, wherein said bending stiffness difference normalized for wall thickness is at least 25%.
